(19) United States
(12) Patent Application Publication
(10) Pub. No.: US 2005/0189746 A1
(43) Pub. Date: Sep. 1, 2005

(54) Side impact protective device, integrated in a seat, and a head side gas bag module, integrated in a seat

(75) Inventors: Andreas Loos, Rechberghausen (DE); Dominique Acker, Gschwend (DE)

Correspondence Address: TAROLLI, SUNDHEIM, COVELL, & TUMMINO L.L.P.;1111 LEADER BLDG., 526 SUPERIOR AVENUE, CLEVELAND, OH, 44114-1400, US

(73) Assignee: TRW Automotive GmbH

(21) Appl. No.: 11/063,507

(22) Filed: Feb. 23, 2005

(30) Foreign Application Priority Data
Feb. 27, 2004 (DE) 10 2004 009 642.2

(51) Int. Cl. B60R 21/22; B60R 22/00

(52) U.S. Cl. 280/730.2; 280/808

(57) ABSTRACT

A side impact protective device integrated in a seat, with a head side gas bag module includes a shell-shaped mounting housing in the upper end region of the backrest. The mounting housing has a web in which a gas bag is housed, and a belt webbing contact surface adjoining to the web. The web serves at the same time as a belt webbing guide.

### TECHNICAL FIELD

The invention relates to a side impact protective device integrated in a seat, and a head side gas bag module integrated in a seat.

### BACKGROUND OF THE INVENTION

It is known to integrate a chest- or a head/chest side gas bag into a vehicle seat. Furthermore, there are also considerations being made to incorporate pure head side gas bags into the seat. These latter pure head side gas bags are to be arranged at an upper end region of a backrest.

It is an object of the invention to improve a side impact protective device integrated in a seat as regards its safety effect. Furthermore, a head side gas bag module integrated in a seat is to be provided, which is distinguished likewise by a good protective function.

### BRIEF SUMMARY OF THE INVENTION

The side impact protective device integrated in a seat, in accordance with the invention, has a head side gas bag provided at an upper end region of a backrest, as well as a belt webbing contact surface provided at the upper end region of the backrest for a shoulder region of a belt webbing. The side impact protective device further includes a belt webbing guide extending between the belt webbing contact surface and the head side gas bag. This belt webbing guide is configured so as to counteract a displacement of the belt webbing over an outlet opening of the head side gas bag. Through the invention, an influencing of the unfolding process of the gas bag by a belt webbing not being positioned correctly is prevented, which can be brought about in that, for example, an occupant moves the belt webbing inadvertently or, with a movement by the occupant, it travels too far laterally outward over the unfolded gas bag. One might say the gas bag is decoupled from the belt.

According to a preferred embodiment, the belt webbing guide is an open guide. By the open guide the belt webbing can be chosen to be removed from the guide without any tools in order to decouple the belt from the backrest, which is especially helpful when reversing the seat or the backrest in the case of a belt not being completely seat-integrated. In particular in a vehicle having two doors and rear seats this arrangement offers the great advantage that the belt webbing can easily be removed from the belt webbing contact surface and the seat. In that case the belt webbing does not represent an obstacle for passengers trying to reach the rear seats through the doors after reversing the front seats.

According to another embodiment of the invention, the belt webbing guide is an openable guide, which means it can be opened and closed again without the aid of tools. For this purpose an unlocking device or a slit, for example, can be provided in the belt webbing guide so that the safety belt can be taken out of the belt webbing guide. By this alternative arrangement, the same advantages can be achieved as by an open guide. It is important that the opening of the guide is not coupled with an opening of the gas bag module.

The belt webbing guide can be an upwardly extending wall or, better, an upwardly extending web.

In order to reduce the number of parts used, the belt webbing guide can be part of a gas bag module housing, so that the position of the belt webbing guide relative to the gas bag is fixed within close limits.

In addition, the gas bag module housing can be configured as a shell in the region of the belt webbing guide, the shell being situated on an upper edge corner region of the backrest and being visible from outside.

According to the preferred embodiment, not only is a guide provided for the belt webbing, but also a guide for the unfolding gas bag. This gas bag guiding on unfolding is achieved by a gas bag guiding wall being provided between the belt webbing contact surface, preferably between the belt webbing guide, and the folded gas bag. The gas bag guiding wall is configured so as to hold the unfolding gas bag spaced apart from the belt webbing.

The gas bag guiding wall lies for example inside a gas bag module and is part of an inner module housing.

Here, for example, a mounting housing provided only for the gas bag can be provided, in which the gas bag is situated and which in turn is at least partially surrounded by an outer housing. In this case the gas bag guiding wall is a part of the mounting housing.

Preferably, an upper portion of the belt webbing is led to a vehicle-fixed part and deflected there. The vehicle-fixed part can for example be a B-pillar or, in the case of a rear seat, a C-pillar of the vehicle. Alternatively, a fully seat-integrated configuration of the belt is of course possible.

The head side gas bag module according to the invention has an outer housing having a belt webbing contact surface and a belt webbing guide adjoining to the contact surface, the belt webbing guide projecting with respect to the belt webbing contact surface.

In the preferred embodiment, the belt webbing guide is part of a projecting web in which the gas bag is housed, so that the gas bag at least partially in the folded state already lies above the belt webbing contact surface, which is intended to prevent a contacting of the belt webbing on emerging.

As already explained, the belt webbing contact surface and the belt webbing guide are preferably to continue into each other in one piece, and the belt webbing guide is to be an open or openable guide, which the belt webbing can be removed from if necessary.

### BRIEF DESCRIPTION OF THE DRAWINGS

FIG. 1 shows a perspective view of a backrest which is cut open in left-hand half and into which a side impact protective device according to the invention, in the form of a head side gas bag module, is integrated,

FIG. 2 shows a perspective view onto the upper end region of the backrest according to FIG. 1 with the side impact protective device according to the invention, and

FIG. 3 shows an exploded view of the side impact protective device according to FIG. 1.

### DETAILED DESCRIPTION OF THE PREFERRED EMBODIMENTS

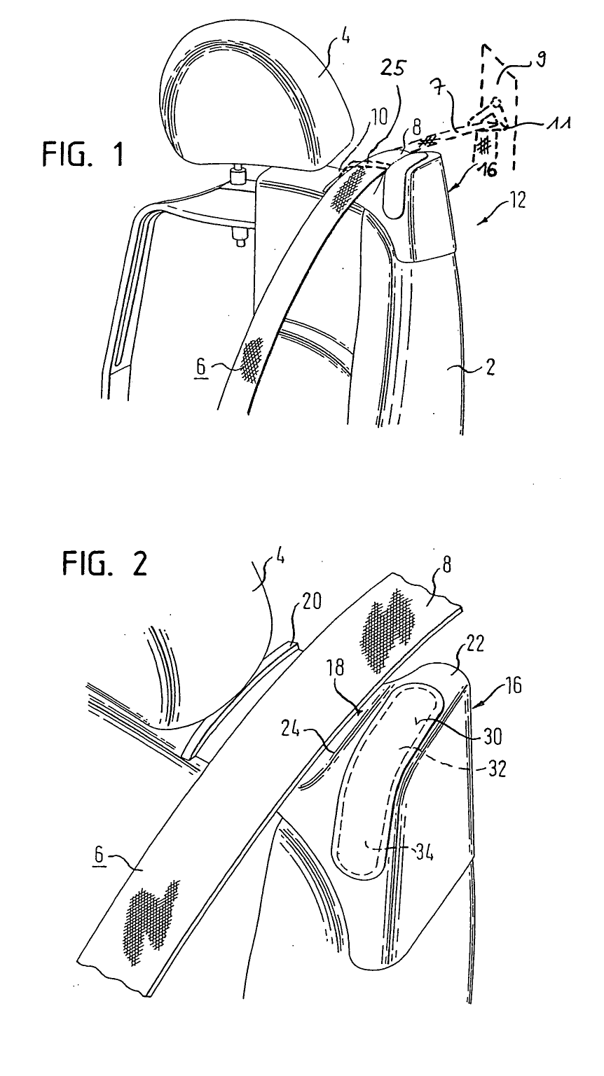

In FIG. 1 a vehicle seat backrest 2 with a headrest 4 and a belt webbing 6 are illustrated. The belt webbing 6 has a shoulder region 8; that is a region of the belt webbing 6 running along an upper end region 10 of the backrest 2. Preferably, the shoulder region 8 of the belt webbing 6 even contacts the upper end region of the backrest 10 both when the safety belt is worn and also when it is not worn, which will be explained later in further detail.

An upper portion 7 of the belt webbing 6 can optionally be led to a vehicle-fixed part 9 and deflected there by a deflection fitting 11. The vehicle-fixed part can be for example a B-pillar or, in the case of a rear seat, a C-pillar of the vehicle. Alternatively, a fully seat-integrated configuration of the belt is of course possible.

A head side gas bag module 12 is integrated into the backrest 2 to provide a side impact protective device integrated in the seat. This is partially visible from outside.

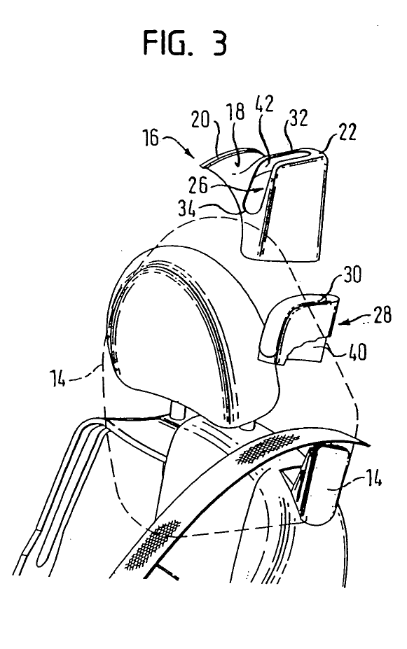

The head side gas bag module comprises a folded head side gas bag 14, which is illustrated in FIG. 3 in a folded state and in outline diagrammatically also in an inflated state.

The gas bag housed in the side gas bag module is a pure head gas bag, i.e. it does not extend downwards into the chest region.

The module has a module outer housing 16 visible from outside having a shell-like configuration, being situated on the upper edge corner region of the backrest 2, and containing the head side gas bag 14.

An extension arm of the module outer housing 16 extends along the upper end or edge of the backrest 2 to almost beneath the headrest 4. A portion of this extension arm runs under the shoulder region 8 of the belt webbing 6 and represents a belt webbing contact surface 18, which is slightly wider than the belt webbing 6 and which is contacted by the belt webbing 6 in the shoulder region 8 when the vehicle belt is not worn and preferably also when it is worn. To the left and right of the belt webbing contact surface, belt webbing guides are formed in one piece on the module outer housing 16. Towards the headrest 4, the module outer housing 16 has a free edge 20 extending upwards in the manner of a bead, the edge representing the belt webbing guide on this side. On the other side of the belt webbing 6, the belt webbing guide 24 is formed by an inner side, facing the belt webbing 6, of an upwardly projecting web 22. Thus, the belt webbing contact surface 18 lies inwards of the folded head side gas bag 14 in a horizontal direction, and the belt webbing guide is positioned between the head side gas bag 14 and the belt webbing contact surface 18. “Inwards” means in direction to a vehicle center.

Optionally, a connecting member 25 with an unlocking device is provided between the edge 20 and the web 22, thereby creating a partly closed, but openable guide.

The shell- or cap-like module outer housing 16 extends a further distance out from the web 22 laterally on the side edge of the backrest 2 downwards (see FIG. 1).

As FIG. 3 shows, the shell-like module outer housing 16 has a shaft 26 into which a separate mounting housing 28, likewise of plastic, is inserted, the mounting housing being constructed in the manner of a cassette and surrounding the gas bag 14. The shaft 26 has an outlet opening for the gas bag 14 closed by a a front wall 30 of the mounting housing 28. The outlet opening has a portion 32 pointing upwards and also a portion 34 pointing forwards, the two portions 32, 34 continuing into each other.

As can be seen in particular in FIG. 3, a majority of the outlet opening lies above the belt webbing contact surface 18. The rear wall of the mounting housing 28, which has a large area and lies between the gas bag 14 and the belt webbing, (see FIG. 3 in the region of the housing section cut away on the front side), serves as a gas bag guiding wall 40 on unfolding of the gas bag 14. The gas bag guiding wall 40 is further assisted by a side wall 42 on the module outer housing 16, the side wall delimiting the shaft 26. The gas bag guiding wall 40 partially contacts the side wall 42.

On unfolding, the gas bag 14 is guided forward and upward by the gas bag guiding wall 40. The wall 40 therefore holds the gas bag 14 spaced apart from the belt webbing 6, both during unfolding and also after unfolding.

The illustrated head side gas bag module integrates but separates the protective functions of the belt and of the gas bag from each other, so that an influencing of the two systems is prevented. On the one hand, the guiding function for the gas bag 14 and on the other hand the fixing function for the safety belt is achieved by a specially constructed housing.

The unfolding of the gas bag 14 is very problematic in the region of the head, because the space conditions between door and seat are extremely restricted. These problems are circumvented by the invention. Furthermore, the gas bag 14 and belt webbing 6 are always positioned optimally with respect to each other independently of the size of the occupant.

As an alternative to the embodiment shown, it is of course possible to construct the belt webbing guide not only as an upwardly completely open guide, but also to embrace the belt webbing 6 towards the top in the manner of a clamp.

Here, if necessary, an unlocking device or a slit may also be provided in the region of the belt webbing guide, so that the safety belt can be taken out from the belt webbing guide when the backrest 2 has to be folded forward. In both cases the seat-integrated head side gas bag module can already be assembled with the seat prior to mounting of the seat. So when mounting the seat in the vehicle, merely the belt webbing has to be put over the belt webbing contact surface, without an additional assembling step being necessary.

1. A side impact protective device for vehicle occupants, integrated in a seat, said side impact protective device comprising
a head side gas bag (14) provided at an upper end region (10) of a backrest (2) and
a belt webbing contact surface (18) for a shoulder region (8) of a belt webbing (6), said belt webbing contact surface (18) being provided in said upper end region (10) of said backrest (2) and
a belt webbing guide (24) extending between said belt webbing contact surface (18) and said head side gas bag (14), said belt webbing guide (24) counteracting a displacement of said belt webbing (6) over an outlet opening (32, 34) for said head side gas bag (14).

2. The side impact protective device according to claim 1, wherein said belt webbing guide (24) is an open guide.

3. The side impact protective device according to claim 1, wherein said belt webbing guide (24) is an openable guide.

4. The side impact protective device according to claim 1, wherein said belt webbing guide (24) is an upwardly extending wall.

5. The side impact protective device according to claim 1, wherein said belt webbing guide (24) is part of an upwardly extending web (22).

6. The side impact protective device according to claim 1, wherein said belt webbing contact surface (18) and said belt webbing guide (24) continue into each other in one piece.

7. The side impact protective device according to claim 1, wherein said belt webbing guide (24) and said belt webbing contact surface (18) are portions of a shell-like part placed onto said upper end region (10) of said backrest (2).

8. The side impact protective device according to claim 1, wherein said belt webbing guide (24) is part of a gas bag module housing.

9. The side impact protective device according to claim 8, wherein said module housing has a shell, said shell being situated on an upper edge corner region of said backrest (2) and being visible from outside.

10. The side impact protective device according to claim 1, wherein a gas bag guiding wall (40) is provided between said belt webbing contact surface (18) and said gas bag (14), said gas bag guiding wall (40) holding the unfolding gas bag (14) spaced apart from said belt webbing (6).

11. The side impact protective device according to claim 10, wherein said gas bag guiding wall (40) lies inside a gas bag module.

12. The side impact protective device according to claim 11, wherein said gas bag guiding wall is part of a mounting housing (28) inside said module, said gas bag (14) being housed in said mounting housing.

13. The side impact protective device according to claim 1, wherein an upper portion (7) of said belt webbing (6) is led to a vehicle-fixed part (9) and deflected there.

14. A head side gas bag module integrated in a seat, said head side gas bag module comprising
an outer housing (16) having a belt webbing contact surface (18) and a belt webbing guide (20, 24) adjoining to said contact surface (18), said belt webbing guide projecting with respect to said belt webbing contact surface (18).

15. The head side gas bag module according to claim 14, wherein said belt webbing guide (24) is part of a projecting web (22) in which said gas bag (14) is housed.

16. The head side gas bag module according to claim 14, wherein a gas bag guiding wall (40) is integrated into said module between said belt webbing contact surface (18) and said gas bag (14).

17. The head side gas bag module according to claim 14, wherein said outer housing has an outlet opening for said gas bag (14), said outlet opening having a portion (32, 34) pointing upwards and forwards.
